(19) United States
(12) Patent Application Publication
(10) Pub. No.: US 2021/0002156 A1
(43) Pub. Date: Jan. 7, 2021

(54) ZERO VALENT IRON CATALYST FOR REDUCTION PROCESSES

(71) Applicant: Ariel Scientific Innovations Ltd., Ariel (IL)

(72) Inventors: Yael ALBO, Petach-Tikva (IL); Dan MEYERSTEIN, Mevaseret Zion (IL); NEELAM, Ariel (IL)

(73) Assignee: Ariel Scientific Innovations Ltd., Ariel (IL)

(21) Appl. No.: 16/969,258

(22) PCT Filed: Feb. 12, 2019
(86) PCT No.: PCT/IL2019/050166

§ 371 Date: Aug. 12, 2020

Related U.S. Application Data
(60) Provisional application No. 62/629,134, filed on Feb. 12, 2018.

(51) Int. Cl. C02F 1/70; B01J 23/745; B01J 35/00

(52) U.S. Cl. CPC C02F 1/70; B01J 23/745; C02F 2101/163; B01J 35/0086; B01J 35/0013

(57) ABSTRACT

A method of reducing a substrate and a system for reducing a substrate are described herein. The method comprises contacting the substrate with a catalytic amount of zero valent iron particles and with a reducing agent, wherein the zero valent iron particles mediate transfer of an electron, hydrogen atom and/or hydride ion from the reducing agent to the substrate. The system comprises zero valent iron particles embedded in a porous matrix, wherein the system is configured for contacting the substrate and a reducing agent with a catalytic amount of the zero valent iron particles in the porous matrix.

### RELATED APPLICATION

This application claims the benefit of priority from U.S. Provisional Patent Application No. 62/629,134 filed on 12 Feb. 2018, the contents of which are incorporated herein by reference in their entirety.

### FIELD AND BACKGROUND OF THE INVENTION

The present invention, in some embodiments thereof, relates to catalysis, and more particularly, but not exclusively, to zero valent iron-based catalysts usable in reduction processes, for example, in processes of reducing pollutants.

Many environmentally harmful pollutants, such as halo-organic compounds, bromate (BrO₃⁻), nitrate (NO₃⁻) and nitro-organic compounds, can be treated by reducing agents, e.g., by electrochemical processes [Zhao et al., Water Res 2014, 51:134-143; Mao et al., Appl Catal B Environ 2014, 160-161:179-187; Zhao et al., Electrochim Acta 2012, 62:181-184; Gupta et al., Water Res 2014, 48:210-217; Li et al., J Hazard Mater 2012, 201-202:250-259].

In treating polluted water samples, it is desirable that the process will be carried out in neutral solutions. A variety of processes for treating polluted aqueous media containing halo-organic compounds [Lifongo et al., Int J Phys Sci 2010, 5:738-747; Lifongo et al., Chemosphere 2004, 55:467-476], bromate [Chen et al., Appl Catal B Environ 2010, 96:307-313; Restivo et al., Chem Eng J 2017, 309:197-205; Neelam et al., Chem Eng J 2017, 330:419-422] and nitro-organic compounds [Yuan et al., Chemosphere 2017, 186:132-139; Menumerov et al., Nano Lett 2016, 16:7791-7797; Kalekar et al., RSC Adv 2016, 6:11911-11920] have been developed.

However, none of the existing processes is optimal and most of them are expensive and often release other chemicals, when applied in the environment.

Zero valent iron (ZVI) and iron nanoparticles (Fe⁰—NPs) have been described for environmental remediation of polluted soils and streams [Ezzatahmadi et al., Chem Eng J 2017, 312:336-350; Adusei-Gyamfi & Acha, RSC Adv 2016, 6:91025-91044; Li et al., Critical Rev Solid State Materials Sci 2006, 31:111-122; Crane & Scott, J Hazard Mater 2012, 211-212:112-125].

ZVI is effective at reducing a broad array of organic compounds, upon oxidation of ZVI to Fe²⁺ [Lien & Zhang, Colloids & Surfaces A: Physiochem Eng Aspects 2001, 191:97-105; Chen et al., IOP Conf Series: Earth Environ Sci 2017, 51:012004].

In addition, ZVI can be used to induce Fenton-like reactions for oxidizing pollutants [Kuan et al., Ind Eng Chem Res 2015, 54:8122-8129; Segura et al., Chem Eng J 2015, 269:298-305; Segura et al., Appl Catal B Environ 2013, 137:64-69; Martins et al., Chem Eng Sci 2013, 100:225-233].

However, these processes are very slow in neutral and slightly alkaline media due to the precipitation of iron hydroxides and oxides on the surface of the ZVI [Guan et al., Water Res 2015, 75:224-248], which inhibits the application of ZVI in batch treatment of polluted aqueous media.

In order to increase the reactivity of ZVI, bimetallic particles have been prepared, composed of ZVI which is sacrificially oxidized, and a less corrosive metal which acts as a catalyst, such as Pd, Pt, Au, Ag, Ni, Co or Cu [Guan et al., Water Res 2015, 75:224-248; Lien & Zhang, Colloids & Surfaces A: Physiochem Eng Aspects 2001, 191:97-105; Zhuang et al., Environ Sci Technol 2011, 45:5896-4903].

Gold nanoparticles (Au°—NPs) [Zhao et al., Coord Chem Rev 2015, 287:114-136; Naseem et al., Environ Sci Pollut Res 2017, 24:6446-6460] and silver nanoparticles (Ag°—NPs) [Rajesh & Venkatesan, J Mol Catal A Chem 2012, 359:88-96] have been reported to catalyze reduction of nitro-aromatic compounds by reducing agents such as sodium borohydride.

Adhikary et al. [Eur J Inorg Chem 2017, 1510-1515] describe a reusable system comprising gold nanoparticles entrapped in a sol-gel silica matrix, which catalyzes reduction of bromoacetic and tribromoacetic acid by sodium borohydride.

The use of Au⁰—NPs and Ag⁰—NPs in solution has been proposed for cleaning contaminated water [Qian et al., J Chem Technol Biotechnol 2013, 88:735-741; Kaegi et al., Environ Sci Technol 2011, 45:3902-3908].

Additional background art includes Altamar et al. [Sensors Actuators B Chem 2010, 146:103-110]; Arnold & Roberts [Environ Sci Technol 2000, 34:1794-1805]; Bhatt et al. [Crit Rev Environ Sci Technol 2007, 37:165-198]; Borojovich et al. [Appl Catal B Environ 2017, 210:255-262]; Bransfield & Livi [Environ Sci Technol 2006, 40:6837-6843]; Cwiertny et al. [Environ Sci Technol 2006, 40:6837-6843]; Dhakshinamoorthy et al. [ACS Catal 2017, 7:2896-2919]; Dror et al. [Environ Sci Technol 2005, 39:1283-1290]; Dror et al., [ACS Appl Mater Interfaces 2012, 4:3416-3423]; Fagadar-Cosma et al. [Open Chem Biomed Methods J 2009, 2:99-106]; Farrell et al. [Environ Sci Technol 2000, 34:514-521]; Fennelly & Roberts [Environ Sci Technol 1998, 32:1980-1988]; He et al. [Int J Electrochem Sci 2011, 6:2932-2942]; Hozalski et al. [Environ Sci Technol 2001, 35:2258-2263]; Kaneda & Mizugaki [ACS Catal 2017, 7:920-935]; Li & Farrell [Environ Sci Technol 2000, 34:173-179]; Lin et al. [J Hazard Mater 2004, 116:219-228]; Lou et al. [Adv Synth Catal 2011, 353:281-286]; Mackenzie et al. [Appl Catal B Environ 2006, 63:161-167]; Manavi et al. [Chem Eng J 2017, 312:375-384]; March J. [Advanced Organic Chemistry Reactions, Mechanisms, and Structure, 4th ed., Wiley 1992]; Meistelman et al. [Catalysis & Biocatalysis 2017, 35(5):16-19]; Muftikian et al. [Water Res 1995, 29:2434-2439]; Ruggeri S. G. [Eliminations, in: S. Caron (Ed.), Pract. Synth. Org. Chem. React. Princ. Tech., Wiley (2011) 383-418]; Rusonik et al. [Eur J Inorg Chem 2003, 4227-4233]; Rusonik et al. [Eur J Inorg Chem 2005, 1227-1229]; Rusonik et al. [Glass Phys Chem 2005, 31:115-118]; Rusonik et al. [Inorg Chem 2006, 45:7389-7396]; Rusonik et al. [Eur J Inorg Chem 2010, 3252-3255]; Shandalov et al. [Tetrahedron Lett 2004, 45:989-992]; Tang et al. [Appl Surf Sci 2015, 333:220-228]; Wong et al. [AIChE Annu Meet Conf Proc 2005, 39:9795]; Wu et al. [Ind Eng Chem Res 2013, 52:12574-12581]; Zha et al. [RSC Adv 2016, 6:16323-16330]; Zhang et al. [Environ Sci Technol 2004, 38:6881-6889]; and International Patent Application Publications WO2006/072944 and WO2007/054936.

### SUMMARY OF THE INVENTION

According to an aspect of some embodiments of the invention, there is provided a method of reducing a substrate, the method comprising contacting the substrate with a catalytic amount of zero valent iron particles and with a reducing agent, wherein the zero valent iron particles mediate transfer of an electron, hydrogen atom and/or hydride ion from the reducing agent to the substrate, thereby reducing the substrate.

According to an aspect of some embodiments of the invention, there is provided a system for reducing a substrate, the system comprising zero valent iron particles embedded in a porous matrix, wherein the system is configured for contacting the substrate and a reducing agent with a catalytic amount of the zero valent iron particles in the porous matrix.

According to some embodiments of the invention, the method (according to any of the respective embodiments described herein) is effected by transfer of electrons, hydrogen atoms and/or hydride ions from the reducing agent to the zero valent iron particles so as to form zero valent iron particles with a negative charge and at least one hydrogen atom bound thereto.

According to some embodiments of any of the embodiments of the invention, the zero valent iron particles are embedded in a porous matrix.

According to some embodiments of any of the embodiments of the invention, contacting the substrate with the zero valent iron particles is effected in aqueous solution.

According to some embodiments of any of the embodiments of the invention, contacting the substrate with the zero valent iron particles is effected in a protic organic solvent and/or in an aprotic organic solvent.

According to some embodiments of the invention, the substrate is a precursor or an intermediate in the synthesis of a product, and the method (according to any of the respective embodiments described herein) comprises reducing the substrate to the product or to an additional intermediate in the synthesis of the product.

According to some embodiments of the invention, the method (according to any of the respective embodiments described herein) comprises reducing the substrate to a product which is less hazardous and/or environmentally harmful than the substrate.

According to some embodiments of the invention, the substrate comprises a halo-organic compound and the method (according to any of the respective embodiments described herein) comprises reducing the substrate to a non-halogenated organic compound.

According to some embodiments of the invention, the substrate comprises bromate, and the method (according to any of the respective embodiments described herein) comprises reducing the bromate to bromide.

According to some embodiments of the invention, the substrate comprises a nitro-organic compound and the method (according to any of the respective embodiments described herein) comprises reducing the substrate to an amino-organic compound.

According to some embodiments of the invention, the substrate comprises nitrate, and the method (according to any of the respective embodiments described herein) comprises reducing the nitrate to ammonia, nitrogen gas and/or hydrazine.

According to some embodiments of the invention, the system (according to any of the respective embodiments described herein) is configured for effecting flow of a fluid comprising the substrate and/or of a fluid comprising the reducing agent through the porous matrix.

According to some embodiments of the invention, the substrate described herein is a precursor or an intermediate in the synthesis of a product, and the system (according to any of the respective embodiments described herein) is configured for reducing the substrate to the product or to an additional intermediate in the synthesis of the product.

According to some embodiments of the invention, the system (according to any of the respective embodiments described herein) is for reducing the substrate to a product which is less hazardous and/or environmentally harmful than the substrate.

According to some embodiments of the invention, the system (according to any of the respective embodiments described herein) is configured for effecting flow of water comprising the substrate through the porous matrix, the system being for decontamination of water.

According to some embodiments of any of the embodiments of the invention, the fluid comprising the substrate comprises a protic or aprotic organic solvent comprising the substrate.

According to some embodiments of any of the embodiments of the invention, a molar ratio of an amount of the substrate to the catalytic amount is at least 10:1 (substrate: iron).

According to some embodiments of any of the embodiments of the invention, the zero valent iron particles comprise zero valent iron nanoparticles.

According to some embodiments of any of the embodiments of the invention, the porous matrix comprises a substance selected from the group consisting of a silica gel, a zeolite, titania and alumina.

According to some embodiments of any of the embodiments of the invention, the reducing agent is characterized by a standard redox potential which is −0.5 V_{SHE} or more negative, in aqueous solution at pH 8.

According to some embodiments of the invention, the standard redox potential is −0.7 V_{SHE} or more negative, in aqueous solution at pH 8.

According to some embodiments of any of the embodiments of the invention, the reducing agent is selected from the group consisting of a borohydride, a metal aluminum hydride, a borane, an aluminum hydride, an alkali metal or alloy thereof, an alkaline earth metal or alloy thereof, zinc or alloy thereof, tin or alloy thereof, a tin hydride, a tin(II) halide, aluminum or alloy thereof, a silane, an azide salt, hydroxylamine, hydrazine, diimide and formic acid.

According to some embodiments of any of the embodiments of the invention, the substrate is hazardous and/or environmentally harmful.

According to some embodiments of any of the embodiments of the invention, the reducing agent is characterized by a standard redox potential which is −0.5 V_{RHE} or less negative.

According to some embodiments of any of the embodiments of the invention, the substrate is selected from the group consisting of a halo-organic compound, bromate, nitrate and a nitro-organic compound.

According to some embodiments of the invention, the halo-organic compound comprises a halogenated carboxylic acid.

According to some embodiments of the invention, the halo-organic compound is a chloro-organic compound and/or a bromo-organic compound.

According to some embodiments of the invention, the nitro-organic compound comprises an aromatic group substituted by at least one nitro.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic depiction of a system for reducing a substrate, according to some embodiments of the invention.

FIG. 2 presents a powder X-ray diffraction pattern (including crystallographic planes attributed to indicated peaks) of a matrix with entrapped ZVI (zero valent iron) nanoparticles according to some embodiments of the invention.

FIG. 3 presents an N₂-adsorption-desorption isotherm of a matrix with entrapped ZVI nanoparticles according to some embodiments of the invention, and graph (inset) showing a distribution of pore radius size of the matrix, calculated from the isotherm.

FIG. 4 presents a Fourier transform infra-red transmission spectrum of a matrix with entrapped ZVI nanoparticles according to some embodiments of the invention (ZVI M-69), and of a corresponding matrix without ZVI (blank).

FIGS. 5A-5C present scanning electron microscopy images of a matrix with entrapped ZVI nanoparticles according to some embodiments of the invention, at magnifications of ×78,410 (FIG. 5A), ×369,240 (FIG. 5B) and x474,160 (FIG. 5C).

FIG. 6 presents an X-ray energy-dispersive spectroscopy (EDS) spectrum of a matrix with entrapped ZVI nanoparticles according to some embodiments of the invention (y-axis represents counts per second, x-axis units are kilo-electron volts (keV)).

FIG. 7 presents absorption spectra showing the conversion of p-nitrophenol (PNP) to p-aminophenol in the presence of a ZVI-entrapped matrix as catalyst (ZVI treated PNP), according to some embodiments of the invention.

FIGS. 8A-8C present ion chromatograms of a mixture of BrO₃⁻ and Br- solution (1×10⁻²M each) with retention time=1.683 and 2.093, respectively (FIG. 8A, red line indicates the integration of peak area); of an exemplary ZVI matrix with water (FIG. 8B, peak at retention time=1.813 is due to Cl⁻ present); and of a ZVI matrix with water following catalysis of reduction of 2×10⁻² M BrO₃⁻ to Br⁻ (with Br⁻ represented by peak at retention time=2.243) according to some embodiments of the invention (FIG. 8C, peak at retention time 1.7 is due to Cl⁻ present).

### DESCRIPTION OF SPECIFIC EMBODIMENTS OF THE INVENTION

The present invention, in some embodiments thereof, relates to catalysis, and more particularly, but not exclusively, to zero valent iron-based catalysts usable in reduction processes, for example, in processes of reducing pollutants.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As discussed hereinabove, the use of sacrificial oxidation of zero valent iron (ZVI), whereby the iron is used as a source of electrons, to reduce substrates is known in the art.

The present inventors have uncovered that zero valent iron (ZVI) is surprisingly effective as a catalyst of reduction of substrates, in the presence of a reducing agent.

Zero valent iron for catalysis is clearly advantageous in the reduction of substrates—including, but not limited to, reduction of pollutants—in being considerably cheaper than noble metal catalysts, which have been used previously for reduction reactions.

Furthermore, the inventors have envisioned that the use of zero valent iron for catalysis can overcome significant problems associated with the use of zero valent iron as a source of electrons. For example, during sacrificial oxidation of zero valent iron, the iron hydroxides and oxides may form on a surface of the iron, and thereby inhibit further reaction of the iron. In addition, sacrificial oxidation of iron articles may entail excessive costs in order to continuously replace the iron particles, for example, in a form of small iron particles embedded in a matrix suitable for a given application.

While reducing the invention to practice, the inventors have prepared porous silica matrices comprising ZVI-nanoparticles and shown that the ZVI-NPs entrapped in the matrix efficiently and reversibly catalyze a wide variety of reduction processes such as de-halogenation of halo-organic acids, reduction of bromate to bromide, and reduction of nitro groups to amine groups, which are useful, for example, in the decontamination of water.

According to an aspect of some embodiments of the invention, there is provided a method of reducing a substrate (according to any of the embodiments described herein regarding a substrate). The method comprises contacting the substrate with a catalytic amount (as defined herein) of zero valent iron (ZVI) particles (according to any of the respective embodiments described herein) and with a reducing agent (according to any of the respective embodiments described herein).

Herein and in the art, the terms “reduce”, “reducing”, “reduction” and variants thereof, in the context of a chemical reaction, refer to transfer of one or more electrons to a compound or substance (referred to herein as a substrate). Transfer of electron(s) encompasses addition of a hydrogen atom to a substrate (which is considered in the art to be essentially equivalent to transfer of an electron along with a hydrogen ion), optionally, but not necessarily, as a replacement of another atom (e.g., an atom from group 15, 16 or 17 of the periodic table); as well as removal of an oxygen atom from a substrate (which is considered in the art to be essentially equivalent to addition of hydrogen atoms to the removed oxygen).

Reduction of a compound and/or substance is generally accompanied by oxidation of another compound and/or substance, wherein “oxidation” refers to transfer of one or more electrons from a compound or substance (essentially as defined hereinabove with respect for reduction, but in reverse). Reduction and accompanying oxidation are also collectively referred to herein and in the art as a “redox” reaction.

Herein, the phrase “reducing agent” refers to an agent capable of effecting reduction, that is, transfer of one or more electrons to a substrate (as defined herein), thereby becoming oxidized as the substrate is reduced.

In some embodiments of any of the embodiments described herein, the ZVI particles mediate transfer of an electron, hydrogen atom and/or hydride ion from the ZVI to the substrate, thereby reducing the substrate.

In some embodiments of any of the embodiments described herein, reduction is effected by transfer of an electron from the reducing agent to the ZVI (e.g., thereby introducing a negative charge on the ZVI), transfer of a hydrogen atom from the reducing agent to the ZVI (e.g., thereby introducing a hydrogen atom attached to a surface of the ZVI), and/or transfer of a hydride ion from the reducing agent to the substrate (e.g., thereby introducing a negative charge on the ZVI as well as a hydrogen atom attached to a surface of the ZVI). In some such embodiments, a ZVI particle comprising at least one negative charge and/or at least one hydrogen atom bound thereto is formed upon contact with the reducing agent.

As will be appreciated by the skilled person, ZVI particles comprising a negative charge or a hydrogen atom bound thereto are often in equilibrium with one another (e.g., in the presence of a source of protons and/or an acceptor of protons), such that the precise proportion of negative charge(s) and bound hydrogen atom(s) is affected by the environment (e.g., in a reversible manner), and may not be particularly important to characterize.

In some embodiments of any of the respective embodiments described herein, a ZVI particle comprising at least one negative charge and/or at least one hydrogen atom bound thereto is capable of directly reducing a substrate upon contact with the substrate, e.g., a substrate which is not reduced upon contact with a ZVI particle without the negative charge(s) and/or hydrogen atom(s) bound thereto.

In some embodiments of any of the embodiments described herein, contacting the substrate with the ZVI is effected in aqueous solution, for example, an aqueous solution of the substrate and/or the reducing agent.

In some embodiments of any of the embodiments described herein, contacting the substrate with the ZVI is effected in an organic solvent (which may substantially consist of one compound or a mixture of compounds), for example, a protic organic solvent and/or an aprotic organic solvent. The organic solvent may optionally be polar or non-polar.

Examples of suitable protic (and polar) organic solvents include, without limitation, carboxylic acids (e.g., formic acid, acetic acid), C₁₋₆-alcohols (e.g., butanol, propanol, ethanol, methanol), and mixtures thereof.

Examples of suitable polar aprotic organic solvents include, without limitation, C₂₋₆-esters (e.g., ethyl acetate, propylene carbonate), C₃₋₆—N-methyl amides (e.g., N-methylpyrrolidone, dimethylformamide), tetrahydrofuran, dioxane, acetonitrile, ionic liquids, and mixtures thereof.

Examples of suitable non-polar aprotic organic solvents include, without limitation, aliphatic or aromatic hydrocarbons (e.g., hexane, benzene, toluene), and linear ethers (e.g., diethyl ether).

The reduction reaction may optionally be enhanced by being performed under anaerobic conditions, so as to reduce oxidation of the substrate, ZVI and/or the reducing agent by oxygen.

Anaerobic conditions may be effected, for example, in the absence of a gaseous atmosphere (e.g., in a liquid in a substantially closed and full container), or in the presence of a gaseous atmosphere which is devoid of oxygen gas or wherein a molar concentration of oxygen therein is substantially less than that of air, e.g., less than 5%, less than 1%, or less than 0.1%.

Zero Valent Iron (ZVI):

Herein throughout, the terms “zero valent iron” and “ZVI” (which are used herein interchangeably) refer to iron in the metallic)(Fe° form. The metallic form encompasses metallic substances (e.g., alloys of iron with one or more other metals) consisting primarily of iron (i.e., in which a molar concentration of iron in the metallic substance is more than 50%).

In some embodiments of any of the embodiments described herein, at least a portion of the metallic substance in ZVI (as defined herein) is formed upon contact with a reducing agent (e.g., according to any of the respective embodiments described herein), for example, by reduction of a metal oxide (e.g., an iron (II) and/or iron (III) oxide, such as FeO, Fe₃O₄, and/or Fe₂O₃), metal hydroxide (e.g., iron (II) hydroxide-Fe(OH)₂; and/or iron (III) oxide-Fe(OH)₃) and/or metal oxyhydroxide (e.g., FeOOH) to the metallic form.

Herein throughout, a “catalytic amount” of a substance (e.g., ZVI in particles described herein) refers to an amount of the substance that is lower than a minimal amount of the substance required to react stoichiometrically with a substrate which participates in a reaction. Thus, a catalytic amount depends on an amount of substrate, and may be regarded in terms of a ratio of an amount of the substance to an amount of a substrate (rather than as an absolute quantity).

For example, when a molar ratio of the substrate (that is reduced) to iron atoms is more than 3:1 (substrate: iron atoms), then the amount of iron is a catalytic amount, as (trivalent) iron atoms may possibly react with three substrate molecules each, but reaction with more substrate is unrealistic under common conditions.

Thus, the reduction described herein stands in sharp contrast to reactions in which ZVI is utilized as a stoichiometric source of electrons for reducing a substrate. Rather, the ZVI is utilized according to embodiments of the invention, in a catalytic manner (mediating electron and/or hydrogen atom and/or hydride transfer), and therefore there is no specific stoichiometric relationship between the amount of ZVI and the amount of substrate that is reduced.

In some embodiments of any of the embodiments described herein, a molar ratio of the amount of the substrate (e.g., reduced in a method according to any of the respective embodiments described herein, and/or in a fluid of a system according to any of the respective embodiments described herein) to the catalytic amount (of ZVI) is at least 5:1 (substrate: iron atoms). In some such embodiments, the molar ratio is at least 10:1. In some embodiments, the molar ratio is at least 20:1. In some embodiments, the molar ratio is at least 50:1. In some embodiments, the molar ratio is at least 100:1. In some embodiments, the molar ratio is at least 300:1. In some embodiments, the molar ratio is at least 1,000:1. In some embodiments, the molar ratio is at least 3,000:1. In some embodiments, the molar ratio is at least 10,000:1. In some embodiments, the molar ratio is at least 100,000:1. In some embodiments, the molar ratio is at least 1,000,000:1.

In some embodiments of any of the embodiments described herein, the ZVI particles comprise ZVI nanoparticles.

Herein, the term “nanoparticles” refers to particles having at least one dimension in the nanometer scale (i.e., less than 1 μm), e.g., an average size of from about 0.5 to about 900 nm, or from about 1 to about 500 nm, from about 0.5 to about 100 nm, from about 0.5 to about 30 nm, or from about 0.5 to about 10 nm, or from 0.5 to about 5 nm. In some embodiments of the present invention the particles have a particle size of from about 1 to about 100 microns.

Without being bound by any particular theory, it is believed that smaller particle sizes are associated with larger active surface areas (for a given mass), which is associated with a more rapid reduction process.

In some embodiments of any of the embodiments described herein, the ZVI particles are embedded in a porous matrix.

The porous matrix may comprise, for example, a substance such as a silica gel (porous silica), a zeolite, titania (TiO₂) and/or alumina (Al₂O₃).

Alternatively or additionally, the porous matrix may comprise a polymer, for example, a cross-linked polymer, such as cross-linked polystyrene or a derivative thereof (e.g., a polymer resin such as used in chromatography).

Herein, the term “porous” refers to a solid material with sufficient voids to allow a fluid to pass through the solid material (e.g., by bulk flow and/or diffusion). A porous material may comprise a continuous solid phase and/or a plurality of solid particles.

In some embodiments of any of the embodiments described herein, a porosity of the porous matrix (percentage of the volume matrix which is a void) is in a range of from 10% to 90%, optionally from 20% to 80%, and optionally from 30% to 70%.

ZVI particles may optionally be embedded in a porous matrix by contact of a porous matrix with the ZVI particles, for example, wherein the average size of the pores of the matrix is larger than the average size of the ZVI particles. Alternatively, the porous matrix may optionally be prepared (e.g., using sol-gel methodology and/or polymerization reactions known in the art) in the presence of ZVI particles, such that the porous matrix is formed with ZVI particles (which may optionally be larger than the matrix pores) embedded therein. Preparation of a porous matrix with ZVI particles using a sol-gel technique is exemplified herein in the Examples section below.

It is expected that during the life of a patent maturing from this application many relevant porous matrices and/or techniques for preparing such matrices will be developed and the scope of the term “porous matrix” is intended to include all such new technologies a priori.

Without being bound by any particular theory, it is believed that the use of ZVI particles in a porous matrix becomes more efficient in many applications when the ZVI particles act as a catalyst (which is not consumed and therefore has a relatively long life), rather than as a sacrificial source of electrons (e.g., according to techniques known in the art) which may entail frequent replacement of matrices depleted in ZVI particles with a new porous matrix.

Reducing Agent:

A reducing agent (as defined herein) in embodiments of the invention may be any suitable compound known in the art.

A reducing agent according to any of the embodiments described in this section may be used in the context of a ZVI, substrate, method or system according to any one of the respective embodiments described herein, except when indicated otherwise.

Examples of suitable reducing agents which may be used in any of the embodiments described herein include, without limitation, borohydrides, metal aluminum hydrides, boranes, aluminum hydrides, alkali metals and alloys (e.g., amalgams, lead alloys) thereof, alkaline earth metals and alloys thereof, zinc and alloys thereof (e.g., zinc amalgam), tin and alloys thereof, tin hydrides, tin(II) halides, aluminum and alloys thereof, hydrazine, diimide (HN═NH), silanes, formic acid, azide salts, and hydroxylamines, as well as substances comprising same or which generate same.

In some embodiments of any of the respective embodiments described herein, the reducing agent is a borohydride, a metal aluminum hydride, a borane, an aluminum hydride, a tin hydride, tin(II) halides, hydrazine, diimide (HN═NH), a silane, formic acid, an azide salt, and/or a hydroxylamine.

In some preferred embodiments of any of the embodiments described herein, the reducing agent is capable of effecting reduction by transfer of a hydride ion therefrom, e.g., transfer of a hydride ion to ZVI (according to any of the respective embodiments described herein).

Examples of reducing agents capable of transferring a hydride ion include, without limitation, a borohydride, a metal aluminum hydride, a borane, and/or an aluminum hydride.

Herein throughout, the term “borohydride” refers to an anion having the formula (BH₄₋ₙRₙ)⁻ and salts thereof, wherein n is 0, 1, 2 or 3, and each R is independently alkyl, alkenyl, alkynyl, cycloalkyl, aryl, heteroalicyclic (bonded via a ring carbon), heteroaryl (bonded via a ring carbon), hydroxy, alkoxy, aryloxy, O-carboxy or cyano (as these groups are defined herein). Preferably, R is C₁₋₄-alkyl (e.g., ethyl, propyl and/or butyl), C₁₋₄—O-carboxy (e.g., acetoxy) or cyano.

In some embodiments of any of the respective embodiments described herein, n is 0, such that the borohydride refers to BH₄⁻ or a salt thereof. Examples of such borohydride salts include, without limitation, LiBH₄, NaBH₄, KBH₄, Ca(BH₄)₂, Ba(BH₄)₂, Sn(BH₄)₂, Al(BH₄)₃, Zn(BH₄)₂, and Ce(BH₄)₃. NaBH₄ is an exemplary borohydride.

In some embodiments of any of the respective embodiments described herein, the borohydride refers to BH₃CN⁻ (wherein n is 1 and R is cyano) or a salt thereof, for example, sodium cyanoborohydride (NaBH₃CN).

In some embodiments of any of the respective embodiments described herein, n is 3. Examples of such borohydrides include, without limitation, triacetoxyborohydride (BH(OC(═O)CH₃)₃⁻) and salts thereof (e.g., sodium triacetoxyborohydride), triethylborohydride (BH(CH₂CH₃)₃⁻) and salts thereof (e.g., lithium triethylborohydride) and tributylborohydride (e.g., tri-sec-butylborohydride (BH(CH(CH₃)CH₂CH₃)₃⁻)) and salts thereof (e.g., lithium tributylborohydride).

Herein, the term “borane” refers to a compound having the formula BH₃₋ₙRₙ, wherein n is 0, 1 or 2 (optionally 0 or 2), and each R is as defined hereinabove with respect to borohydride. Preferably, R is alkyl (e.g., pentyl) or cycloalkyl (e.g., cyclohexyl). The term “borane” encompasses diboranes, which are dimers of boranes having the aforementioned formula (as boranes commonly dimerize spontaneously).

Herein, the phrase “metal aluminum hydride” refers to a salt comprising a metal cation (optionally Lit) and an anion having the formula (AlH₄₋ₙRₙ)⁻ and salts thereof, wherein n is 0, 1, 2 or 3 (optionally 0 or 3), and R is as defined hereinabove with respect to borohydride. Preferably, R is C₁₋₄-alkoxy (e.g., methoxy, ethoxy and/or butoxy). Examples of suitable metal aluminum hydrides include, without limitation, lithium aluminum hydride (LiAlH₄); metal trimethoxyaluminum hydrides, such as lithium trimethoxyaluminum hydride (LiAlH(OCH₃)₃); metal triethoxyaluminum hydrides, such as lithium triethoxyaluminum hydride (LiAlH(OCH₂CH₃)₃); and metal tributoxyaluminum hydrides (e.g., tri-t-butoxyaluminum hydrides), such as lithium tri-t-butoxyaluminum hydride (LiAlH(OC(CH₃)₃)₃).

Herein, the term “aluminum hydride” (when not part of the phrase “metal aluminum hydride”, as defined herein) refers to a compound the formula AlH₃₋ₙRₙ, wherein n is 0, 1 or 2, and R is as defined hereinabove. Preferably, R is C₁₋₄-alkyl (e.g., ethyl, propyl and/or butyl). Examples of suitable aluminum hydrides include, without limitation, AlH₃ (wherein n is 0) and dialkylaluminum hydrides (wherein n is 2 and R is alkyl) such as diisobutylaluminum hydride.

Examples of suitable alkali metals include, without limitation, Li, Na and K.

Examples of suitable alkaline earth metals include, without limitation, Ca and Mg.

Herein, the term “tin hydride” refers to a compound the formula SnH₄₋ₙRₙ, wherein n is 0, 1, 2 or 3, and R is as defined hereinabove. Preferably, R is alkyl, e.g., C₁₋₄-alkyl (e.g., ethyl, propyl and/or butyl). Examples of suitable tin hydrides include trialkyltin hydrides (wherein n is 3 and R is alkyl) such as tributyltin hydride.

Examples of suitable tin(II) halides include, without limitation, SnCl₂ and SnBr₂.

Herein, the term “silane” refers to a compound the formula SiH₄₋ₙRₙ, wherein n is 0, 1, 2 or 3, and R is as defined hereinabove. Preferably, R is C₁₋₄-alkyl (e.g., methyl or ethyl) or aryl (e.g., phenyl). Examples of suitable silanes include trialkylsilane (wherein n is 3 and R is alkyl) such as triethylsilane, and diphenylsilane (wherein n is 2).

The reducing agent is optionally selected so as not to have a reducing capability (as characterized, e.g., by standard redox potential) that is too strong (e.g., so as to be unstable and/or induce uncontrolled reduction) and/or too weak (e.g., so as to be ineffective at reducing the ZVI and/or substrate) for a given purpose. The skilled person will be capable of selecting a suitable reducing capability for a given purpose.

Herein throughout, the phrase “standard redox potential” refers to a redox potential relative to an indicated standard electrode (e.g., a standard hydrogen electrode or a reversible hydrogen electrode), under standard conditions used in the art, e.g., a temperature of 25° C., a partial pressure of 1 atmosphere for each gas that is part of the reaction, and a 1 M concentration of each solute that is part of the reaction (with the exception of hydrogen and hydroxide ions, which are determined by an indicated pH, as described herein).

In some embodiments of any of the embodiments described herein, the reducing agent is characterized by a standard redox potential that is −0.5 V_{SHE} or more negative (in aqueous solution at pH 8). In some such embodiments, the standard redox potential of the reducing agent is −0.6 V_{SHE} or more negative. In some embodiments, the standard redox potential of the reducing agent is −0.7 V_{SHE} or more negative. In some embodiments, the standard redox potential of the reducing agent is −0.8 V_{SHE} or more negative. In some embodiments, the standard redox potential of the reducing agent is −0.9 V_{SHE} or more negative. In some embodiments, the standard redox potential of the reducing agent is −1.0 V_{SHE} or more negative.

In exemplary embodiments, the reducing agent is characterized by a standard redox potential of about −0.9 V_{SHE} in aqueous solution at pH 8.

Herein, the term “SHE” refers to a standard hydrogen electrode as defined in the art—e.g., wherein a concentration of hydrogen ion (like other solutes) is 1 M, such that the pH is 0—and “V_{SHE}” refers to a potential determined relative to an SHE as standard electrode.

It is to be appreciated that the abovementioned aqueous solution at pH 8 does not in any way indicate that the reduction of a substrate according to any of the respective embodiments described herein is necessarily effected in an aqueous solution (let alone at pH 8). Rather, such an aqueous solution merely refers to conditions under which an indicated standard redox potential (according to respective embodiments) is determined.

Without being bound by any particular theory, it is believed that reducing agents characterized by a standard redox potential which is −0.5 V_{SHE} or more negative (in aqueous solution at pH 8) will be more effective at reducing ZVI than weaker reducing agents (with a more positive standard redox potential). It is further believed that the oxidized derivative of the reducing agent (obtained upon reduction by the reducing agent) will be less capable of oxidizing ZVI (e.g., to Fe²⁺) when the standard redox potential which is −0.5 V_{SHE} or more negative (in aqueous solution at pH 8), as compared with weaker reducing agents and their oxidized derivatives. For example, the standard redox potential for oxidation of ZVI to Fe²⁺ (and reduction of Fe²⁺ to ZVI) is −0.44 V_{SHE} at pH values below about pH 9.

In some embodiments of any of the embodiments described herein, the reducing agent is characterized by a standard redox potential that is −0.5 V_{RHE} or less negative. In some such embodiments, the standard redox potential of the reducing agent is −0.4 V_{RHE} or less negative. In some embodiments, the standard redox potential of the reducing agent is −0.3 V_{RHE} or less negative.

Herein, the term “RHE” refers to a reversible hydrogen electrode as used in the art, and “V_{RHE}” refers to a potential determined relative to an RHE as standard electrode. For potentials relative to RHE, the standard conditions comprise any pH of a solution being used, for example, an aqueous solution according to any of the respective embodiments described herein.

A standard redox potential relative to RHE is optionally determined experimentally (e.g., wherein the reducing agent and RHE are at the same pH) according to techniques known in the art. Alternatively, a potential relative to RHE may be determined based on a potential relative to SHE, modified to take into account a calculated effect of a difference in pH on the potential (e.g., using the Nernst equation, as known in the art).

Determination of V_{RHE} (experimentally or via calculation) is optionally under conditions (e.g., pH) at which a reducing agent is contacted with ZVI (according to any of the respective embodiments described herein) and/or at pH 8. However, it is noted that the standard redox potential (in V_{RHE}) of many reducing agents is substantially independent of pH (e.g., because the RHE and the reducing agent are affected similarly by pH).

Without being bound by any particular theory, it is believed that reducing agents characterized by a standard redox potential which is about −0.5 V_{RHE} or less negative (according to any of the respective embodiments described herein) are sufficiently mild reducing agents so as to avoid reaction with water (e.g., by forming H₂) at a significantly detrimental rate (e.g., so as to significantly reduce a degree of reduction of the substrate), and are thus particularly suitable for effecting reduction in the presence of water (e.g., in aqueous solution) according to any of the respective embodiments described herein.

For example, borohydride is characterized by a standard redox potential of about −0.41 V_{RHE}, and is readily capable of effecting reduction in aqueous solution according to some embodiments of the solution, as exemplified in the Examples section herein.

In some embodiments of any of the embodiments described herein, contacting the substrate with the ZVI is effected in the presence of water, e.g., in aqueous solution, and the reducing agent is an agent stable in the presence of water.

Herein, “stable in the presence of water” refers to a compound (e.g., reducing agent according to any of the respective embodiments described herein) which does not react with water or which reacts with water at a sufficiently low rate such that no more than 50% of the compound reacts with water after exposure to excess water (e.g., bulk water) for 10 minutes. In some of any of the respective embodiments, no more than 50% of the compound reacts with water after exposure to excess water for 30 minutes. In some of any of the respective embodiments, no more than 50% of the compound reacts with water after exposure to excess water for 6o minutes. In some of any of the respective embodiments, no more than 50% of the compound reacts with water after exposure to excess water for 24 hours.

It is expected that during the life of a patent maturing from this application many relevant reducing agents will be developed and the scope of the term “reducing agent” is intended to include all such new technologies a priori.

Substrate:

The substrate according to embodiments of the invention may optionally be any compound and/or substance known in the art which is capable of being reduced in the presence of a reducing agent (e.g., a reducing agent according to any of the respective embodiments described herein), for example, wherein a reaction comprising reduction of the substrate (along with oxidation of the reducing agent) is characterized by a reduction in free energy.

Reduction of a substrate (e.g., according to any of the respective embodiments described herein) is useful in a wide variety of applications, including, for example, chemical synthesis (e.g., in industrial scale and/or small scale syntheses) and in pollution mitigation (e.g., at a source of the pollution and/or in an environmental clean-up).

In some embodiments of any of the embodiments described herein, the substrate is a precursor (e.g., a raw material) or an intermediate in the synthesis of a product (wherein the synthesis comprises at least one reduction reaction), and the substrate is reduced (e.g., according to any of the respective embodiments described herein) to the product of the synthesis or to an additional intermediate in the synthesis (from which the product is obtained by further processing of the additional intermediate).

In some embodiments of any of the embodiments described herein, the substrate is hazardous and/or environmentally harmful. In some such embodiments, the reduction of the substrate (according to any of the respective embodiments described herein) is to a product that is less hazardous and/or environmentally harmful than the substrate.

In some embodiments of any of the embodiments described herein, the substrate is a halo-organic compound, a nitro-organic compound, bromate or nitrate. Such compounds may optionally be, e.g., pollutants in an aqueous solution.

Herein, the term “halo-organic” refers to an organic compound (as defined in the art) comprising at least one halogen atom that is covalently bound to a carbon atom, for example, a carbon atom of an alkyl, alkenyl, alkynyl, cycloalkyl, heteroalicyclic, aryl and/or heteroaryl group (as these groups are defined herein).

In some embodiments of any of the embodiments described herein, the halo-organic compound comprises at least one chlorine, bromine and/or iodine atom covalently bound to a carbon atom. Without being bound to any particular theory, it is believed that covalent bonds between such halogen atoms and carbon are particularly susceptible to cleavage by reduction reactions (e.g., relative to carbon-fluorine bonds).

Examples of halo-organic compounds include, without limitation, chloro-organic compounds (i.e., wherein at least one chlorine atom is covalently bound to a carbon atom) and bromo-organic compounds (i.e., wherein at least one bromine atom is covalently bound to a carbon atom).

In some embodiments of any of the embodiments described herein, reduction comprises reducing a halo-organic compound (as defined herein) of a substrate to a non-halogenated organic compound, i.e., an organic compound that is not a halo-organic compound as defined herein. In some embodiments, reduction of a halo-organic compound is effected by replacing all of the halogen atoms of the halo-organic compound with hydrogen atoms.

In exemplary embodiments, the halo-organic compound comprises a halogenated carboxylic acid, that is, a compound comprising at least one —CO₂H group (or salt thereof) and at least one halogen atom which is covalently bound to a carbon atom (not in the carboxylic acid group). Exemplary halo-organic carboxylic acids include chloroacetic acid, dichloroacetic acid, trichloroacetic acid, bromoacetic acid, dibromoacetic acid and tribromoacetic acid.

Herein, the term “nitro-organic” refers to a compound comprising at least one nitro group (—NO₂) that is covalently bound to a carbon atom.

In some of any of the respective embodiments described herein, the nitro-organic compound comprises an aromatic (i.e., aryl or heteroaryl) group substituted by at least one nitro group (e.g., a nitrophenyl or dinitrophenyl group). Nitrophenol is an exemplary aromatic nitro-organic compound.

In some embodiments of any of the embodiments described herein, reduction comprises reducing a nitro-organic compound (as defined herein) of a substrate to an amino-organic compound, i.e., an organic compound comprising an amine group. In some embodiments, reduction of a nitro-organic compound is effected by reducing all nitro groups therein to amine groups.

In some embodiments of any of the embodiments described herein relating to halo-organic and/or nitro-organic compounds, the reduction comprises removing the halo-organic and/or nitro-organic compounds from waste water (e.g., industrial wastewater and/or agricultural runoff) and/or ground water (e.g., ground water contaminated by halo-organic and/or nitro-organic compounds) by reduction of the halo-organic and/or nitro-organic compounds. Halo-organic compounds and/or nitro-organic compounds that contaminate water may originate, for example, in an industrial use (e.g., a halo-organic compound used in industrial synthesis and/or as a solvent), agricultural use (e.g., a halo-organic or nitro-organic pesticide), and/or nitro-organic compound used as an explosive (e.g., in a military depot and/or industry) or as a coloring agent and/or dye (e.g., in a fabric industry).

In some embodiments of any of the embodiments described herein, reduction comprises reducing bromate (BrO₃⁻) in a substrate to bromide (Br⁻).

In some embodiments of any of the embodiments described herein, reduction comprises reducing nitrate (NO₃⁻) in a substrate to ammonia (NH₃), N₂ (nitrogen gas) and/or hydrazine (H₂N—NH₂).

A bromate or nitrate substrate may be, for example, part of a salt comprising bromate or nitrate ion, respectively.

In some embodiments of any of the embodiments described herein relating to bromate, the reduction comprises removing bromate from a water supply (e.g., drinking water) by reduction of the bromate. A water supply contaminated with bromate may comprise water treated by ozone (e.g., as an alternative to or in addition to chlorination) and/or water exposed to sunlight (e.g., in a reservoir), each of which may result in oxidation of (innocuous) bromide to bromate (a suspected carcinogen).

In some embodiments of any of the embodiments described herein relating to nitrate, the reduction comprises removing nitrate from waste water (e.g., from a sewage system, a drainage system, industrial wastewater, and/or agricultural runoff) and/or ground water (e.g., ground water contaminated by nitrate-containing waste water) by reduction of the nitrate. Nitrate that contaminates water may originate, for example, in sewage and/or fertilizer.

System:

According to an aspect of some embodiments of the invention, there is provided a system for reducing a substrate (e.g., according to any of the embodiments described herein relating to a method of reducing a substrate). In some of the embodiments, the system comprises ZVI particles embedded in a porous matrix wherein the system is configured for contacting the substrate and a reducing agent with a catalytic amount of ZVI particles in the porous matrix.

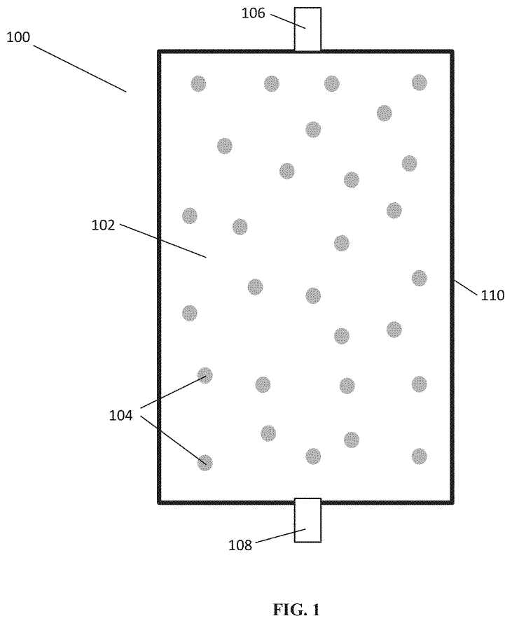

FIG. 1 illustrates a representative and non-limiting example of a system 100 for reducing a substrate. System 100 comprises a porous matrix 102, and a plurality of ZVI particles 104 embedded in porous matrix 102.

In some embodiments of any of the respective embodiments described herein, system 100 is configured for effecting contact of the substrate (according to any of the respective embodiments described herein) and/or the reducing agent (according to any of the respective embodiments described herein) with porous matrix 102, including with particles 104 embedded therein, for example, via one or more optional inlet 106 into matrix 102.

In some embodiments of any of the respective embodiments described herein, system 100 is configured for effecting removal of the substrate (according to any of the respective embodiments described herein) and/or the reducing agent (according to any of the respective embodiments described herein) from porous matrix 102, for example, via one or more optional outlet 108. An apparatus for effecting flow of a fluid (e.g., a pump) may optionally be in operative communication with matrix 102, inlet 106 and/or outlet 108.

In some embodiments of any of the respective embodiments described herein, system 100 is configured for effecting flow of a fluid (e.g., gas or liquid) comprising a substrate (according to any of the respective embodiments described herein) and/or a fluid (e.g., gas or liquid) comprising a reducing agent (according to any of the respective embodiments described herein) through porous matrix 102, for example, by effecting flow of a fluid through one or more optional inlet 106 into matrix 102, and/or by effecting flow of a fluid through one or more optional outlet 108 out from matrix 102. An apparatus for effecting flow of a fluid (e.g., a pump) may optionally be in operative communication with matrix 102, inlet 106 and/or outlet 108. In some embodiments, system 100 is configured for effecting flow of a first fluid comprising the substrate through a first inlet 106, and a second fluid comprising the reducing agent through a second inlet 106.

In some embodiments of any of the respective embodiments described herein, surface 110 of matrix 102 a barrier which is substantially impermeable to the substrate, product(s) of reducing the substrate, reducing agent and/or fluid comprising the substrate and/or reducing agent, e.g., such that substrate, product(s), reducing agent and/or fluid passing through porous matrix 102 is directed towards outlet 108.

The system may optionally be adapted for flow of aqueous fluids and/or fluids comprising any one or more organic solvent described herein, according to any of the respective embodiments.

In some embodiments of any of the respective embodiments described herein, system 100 is configured for effecting flow of water comprising a substrate (according to any of the respective embodiments described herein) through porous matrix 102. In some such embodiments, system 100 is for decontamination of water, or another solvent, e.g., wherein the substrate is a hazardous and/or environmentally harmful substrate (according to any of the respective embodiments described herein) contaminating the water.

Decontamination of waste (e.g., industrial waste and/or sewage) may optionally be effected, for example, by a system (according to any of the respective embodiments described herein) configured to receive a liquid (e.g., contaminated water) from a source of waste (e.g., in a factory), and to release a suitably decontaminated liquid (upon reduction of a contaminant, according to any of the respective embodiments described herein) to a suitable location, e.g., a large body of water or a waste basin, and/or to a system for additional remediation of the waste.

Decontamination of a contaminated source of water (e.g., contaminated groundwater) may optionally be effected, for example, by a system (according to any of the respective embodiments described herein) configured to receive contaminated water (e.g., pumped from the ground), and to release suitably decontaminated water (upon reduction of a contaminant, according to any of the respective embodiments described herein) to a water supply system (e.g., a reservoir, and/or an agricultural and/or municipal water system), back to a source of the water (e.g., back into the groundwater), and/or to a system for additional remediation of the source of water.

Removal of bromate from a bromate-contaminated source of water (e.g., water treated by ozone and/or exposed to sunlight) according to any of the respective embodiments described herein may optionally be effected, for example, by incorporating a system for reducing bromate (according to any of the respective embodiments described herein) into a water supply system, the system for reducing bromate being configured to receive contaminated water from a bromate-generating source (e.g., an ozone water treatment system or a reservoir exposed to sunlight) and to release suitably decontaminated water downstream through the water supply system.

In some embodiments of any of the respective embodiments described herein, system 100 is configured for reducing a substrate which is an intermediate in the synthesis of a product to the product or to an additional intermediate in the synthesis of the product (e.g., according to any of the respective embodiments described herein). For example, system 100 may optionally be configured for receiving the substrate from an apparatus (e.g., optionally in operative communication with system 100) that produces the substrate (e.g., as an intermediate); and/or configured for transferring the additional intermediate to an apparatus (e.g., optionally in operative communication with system 100) that further processes the additional intermediate.

### Additional Definitions and Information

As used herein throughout, the term “alkyl” refers to any saturated aliphatic hydrocarbon including straight chain and branched chain groups. Preferably, the alkyl group has 1 to 20 carbon atoms. Whenever a numerical range (e.g., “1-20”) is stated herein, it implies that the group, in this case the alkyl group, may contain 1 carbon atom, 2 carbon atoms, 3 carbon atoms, etc., up to and including 20 carbon atoms. More preferably, the alkyl is a medium size alkyl having 1 to 10 carbon atoms. Most preferably, unless otherwise indicated, the alkyl is a lower alkyl having 1 to 4 carbon atoms. The alkyl group may be substituted or non-substituted. When substituted, the substituent group can be, for example, cycloalkyl, aryl, heteroaryl, heteroalicyclic, halo, hydroxy, alkoxy, aryloxy, thiohydroxy, thioalkoxy, thioaryloxy, sulfinyl, sulfonyl, sulfonate, sulfate, cyano, nitro, azide, phosphonyl, phosphinyl, oxo, carbonyl, thiocarbonyl, urea, thiourea, O-carbamyl, N-carbamyl, O-thiocarbamyl, N-thiocarbamyl, C-amido, N-amido, C-carboxy, O-carboxy, sulfonamido, guanyl, guanidinyl, hydrazine, hydrazide, thiohydrazide, and/or amino, as these terms are defined herein.

Herein, the term “alkenyl” describes an unsaturated aliphatic hydrocarbon comprise at least one carbon-carbon double bond, including straight chain and branched chain groups. Preferably, the alkenyl group has 2 to 20 carbon atoms. More preferably, the alkenyl is a medium size alkenyl having 2 to 10 carbon atoms. Most preferably, unless otherwise indicated, the alkenyl is a lower alkenyl having 2 to 4 carbon atoms. The alkenyl group may be substituted or non-substituted. Substituted alkenyl may have one or more substituents, whereby each substituent group can independently be, for example, cycloalkyl, alkynyl, aryl, heteroaryl, heteroalicyclic, halo, hydroxy, alkoxy, aryloxy, thiohydroxy, thioalkoxy, thioaryloxy, sulfinyl, sulfonyl, sulfonate, sulfate, cyano, nitro, azide, phosphonyl, phosphinyl, oxo, carbonyl, thiocarbonyl, urea, thiourea, O-carbamyl, N-carbamyl, O-thiocarbamyl, N-thiocarbamyl, C-amido, N-amido, C-carboxy, O-carboxy, sulfonamido, guanyl, guanidinyl, hydrazine, hydrazide, thiohydrazide, and/or amino.

Herein, the term “alkynyl” describes an unsaturated aliphatic hydrocarbon comprise at least one carbon-carbon triple bond, including straight chain and branched chain groups. Preferably, the alkynyl group has 2 to 20 carbon atoms. More preferably, the alkynyl is a medium size alkynyl having 2 to 10 carbon atoms. Most preferably, unless otherwise indicated, the alkynyl is a lower alkynyl having 2 to 4 carbon atoms. The alkynyl group may be substituted or non-substituted. Substituted alkynyl may have one or more substituents, whereby each substituent group can independently be, for example, cycloalkyl, alkenyl, aryl, heteroaryl, heteroalicyclic, halo, hydroxy, alkoxy, aryloxy, thiohydroxy, thioalkoxy, thioaryloxy, sulfinyl, sulfonyl, sulfonate, sulfate, cyano, nitro, azide, phosphonyl, phosphinyl, oxo, carbonyl, thiocarbonyl, urea, thiourea, O-carbamyl, N-carbamyl, O-thiocarbamyl, N-thiocarbamyl, C-amido, N-amido, C-carboxy, O-carboxy, sulfonamido, guanyl, guanidinyl, hydrazine, hydrazide, thiohydrazide, and/or amino.

A “cycloalkyl” group refers to a saturated on unsaturated all-carbon monocyclic or fused ring (i.e., rings which share an adjacent pair of carbon atoms) group wherein one of more of the rings does not have a completely conjugated pi-electron system. Examples, without limitation, of cycloalkyl groups are cyclopropane, cyclobutane, cyclopentane, cyclopentene, cyclohexane, cyclohexadiene, cycloheptane, cycloheptatriene, and adamantane. A cycloalkyl group may be substituted or non-substituted. When substituted, the substituent group can be, for example, alkyl, alkenyl, alkynyl, cycloalkyl, aryl, heteroaryl, heteroalicyclic, halo, hydroxy, alkoxy, aryloxy, thiohydroxy, thioalkoxy, thioaryloxy, sulfinyl, sulfonyl, sulfonate, sulfate, cyano, nitro, azide, phosphonyl, phosphinyl, oxo, carbonyl, thiocarbonyl, urea, thiourea, O-carbamyl, N-carbamyl, O-thiocarbamyl, N-thiocarbamyl, C-amido, N-amido, C-carboxy, O-carboxy, sulfonamido, guanyl, guanidinyl, hydrazine, hydrazide, thiohydrazide, and/or amino, as these terms are defined herein. When a cycloalkyl group is unsaturated, it may comprise at least one carbon-carbon double bond and/or at least one carbon-carbon triple bond.

An “aryl” group refers to an all-carbon monocyclic or fused-ring polycyclic (i.e., rings which share adjacent pairs of carbon atoms) groups having a completely conjugated pi-electron system. Examples, without limitation, of aryl groups are phenyl, naphthalenyl and anthracenyl. The aryl group may be substituted or non-substituted. When substituted, the substituent group can be, for example, alkyl, alkenyl, alkynyl, cycloalkyl, aryl, heteroaryl, heteroalicyclic, halo, hydroxy, alkoxy, aryloxy, thiohydroxy, thioalkoxy, thioaryloxy, sulfinyl, sulfonyl, sulfonate, sulfate, cyano, nitro, azide, phosphonyl, phosphinyl, carbonyl, thiocarbonyl, urea, thiourea, O-carbamyl, N-carbamyl, O-thiocarbamyl, N-thiocarbamyl, C-amido, N-amido, C-carboxy, O-carboxy, sulfonamido, guanyl, guanidinyl, hydrazine, hydrazide, thiohydrazide, and/or amino, as these terms are defined herein.

A “heteroaryl” group refers to a monocyclic or fused ring (i.e., rings which share an adjacent pair of atoms) group having in the ring(s) one or more atoms, such as, for example, nitrogen, oxygen and sulfur and, in addition, having a completely conjugated pi-electron system. Examples, without limitation, of heteroaryl groups include pyrrole, furan, thiophene, imidazole, oxazole, thiazole, pyrazole, pyridine, pyrimidine, quinoline, isoquinoline and purine. The heteroaryl group may be substituted or non-substituted. When substituted, the substituent group can be, for example, alkyl, alkenyl, alkynyl, cycloalkyl, aryl, heteroaryl, heteroalicyclic, halo, hydroxy, alkoxy, aryloxy, thiohydroxy, thioalkoxy, thioaryloxy, sulfinyl, sulfonyl, sulfonate, sulfate, cyano, nitro, azide, phosphonyl, phosphinyl, carbonyl, thiocarbonyl, urea, thiourea, O-carbamyl, N-carbamyl, O-thiocarbamyl, N-thiocarbamyl, C-amido, N-amido, C-carboxy, O-carboxy, sulfonamido, guanyl, guanidinyl, hydrazine, hydrazide, thiohydrazide, and/or amino, as these terms are defined herein.

A “heteroalicyclic” group refers to a monocyclic or fused ring group having in the ring(s) one or more atoms such as nitrogen, oxygen and sulfur. The rings may also have one or more double bonds. However, the rings do not have a completely conjugated pi-electron system. The heteroalicyclic may be substituted or non-substituted. When substituted, the substituted group can be, for example, alkyl, alkenyl, alkynyl, cycloalkyl, aryl, heteroaryl, heteroalicyclic, halo, hydroxy, alkoxy, aryloxy, thiohydroxy, thioalkoxy, thioaryloxy, sulfinyl, sulfonyl, sulfonate, sulfate, cyano, nitro, azide, phosphonyl, phosphinyl, oxo, carbonyl, thiocarbonyl, urea, thiourea, O-carbamyl, N-carbamyl, O-thiocarbamyl, N-thiocarbamyl, C-amido, N-amido, C-carboxy, O-carboxy, sulfonamido, guanyl, guanidinyl, hydrazine, hydrazide, thiohydrazide, and/or amino, as these terms are defined herein. Representative examples are piperidine, piperazine, tetrahydrofuran, tetrahydropyran, morpholine and the like.

Herein, the terms “amine” and “amino” each refer to either a —NR′R″ group or a —N⁺R′R″R′″ group, wherein R′, R″ and R′″ are each independently hydrogen or (substituted or non-substituted) alkyl, alkenyl, alkynyl, cycloalkyl, aryl, heteroalicyclic (bound to the nitrogen via a ring carbon) or heteroaryl (bound to the nitrogen via a ring carbon), as these groups are defined herein. Optionally, R′ and R″ (and R′″, if present) are hydrogen or alkyl comprising 1 to 4 carbon atoms. Optionally, R′ and R″ (and R′″, if present) are hydrogen. When substituted, the carbon atom of an R′, R″ or R′″ hydrocarbon moiety which is bound to the nitrogen atom of the amine is preferably not substituted by oxo, such that R′, R″ and R′″ are not (for example) carbonyl, C-carboxy or amide, as these groups are defined herein, unless indicated otherwise.

An “azide” group refers to a —N═N⁺═N⁻ group.

An “alkoxy” group refers to both an —O-alkyl and an —O-cycloalkyl group, as defined herein.

An “aryloxy” group refers to both an —O-aryl and an —O-heteroaryl group, as defined herein.

A “hydroxy” group refers to a —OH group.

A “thiohydroxy” or “thiol” group refers to a —SH group.

A “thioalkoxy” group refers to both an —S-alkyl group, and an —S-cycloalkyl group, as defined herein.

A “thioaryloxy” group refers to both an —S-aryl and an —S-heteroaryl group, as defined herein.

A “carbonyl” or “acyl” group refers to a —C(═O)—R′ group, where R′ is defined as hereinabove.

A “thiocarbonyl” group refers to a —C(═S)—R′ group, where R′ is as defined herein.

A “carboxy” refers to both “C-carboxy” and O-carboxy”.

A “C-carboxy” group refers to a —C(═O)—O—R′ groups, where R′ is as defined herein.

An “O-carboxy” group refers to an R′C(═O)—O— group, where R′ is as defined herein.

A “carboxylic acid” refers to a —C(═O)OH group, including the deprotonated ionic form and salts thereof.

An “oxo” group refers to a ═O group.

A “thiocarboxy” or “thiocarboxylate” group refers to both —C(═S)—O—R′ and —O—C(═S)R′ groups.

A “halo” group refers to fluorine, chlorine, bromine or iodine.

A “sulfinyl” group refers to an —S(═O)—R′ group, where R′ is as defined herein.

A “sulfonyl” group refers to an —S(═O)₂—R′ group, where R′ is as defined herein.

A “sulfonate” group refers to an —S(═O)₂—O—R′ group, where R′ is as defined herein.

A “sulfate” group refers to an —O—S(═O)₂—O—R′ group, where R′ is as defined as herein.

A “sulfonamide” or “sulfonamido” group encompasses both S-sulfonamido and N-sulfonamido groups, as defined herein.

An “S-sulfonamido” group refers to a —S(═O)₂—NR′R″ group, with each of R′ and R″ as defined herein.

An “N-sulfonamido” group refers to an R'S(═O)₂—NR″ group, where each of R′ and R″ is as defined herein.

An “O-carbamyl” group refers to an —OC(═O)—NR′R″ group, where each of R′ and R″ is as defined herein.

An “N-carbamyl” group refers to an R′OC(═O)—NR″— group, where each of R′ and R″ is as defined herein.

A “carbamyl” or “carbamate” group encompasses O-carbamyl and N-carbamyl groups.

An “O-thiocarbamyl” group refers to an —OC(═S)—NR′R″ group, where each of R′ and R″ is as defined herein.

An “N-thiocarbamyl” group refers to an R′OC(═S)NR″— group, where each of R′ and R″ is as defined herein.

A “thiocarbamyl” or “thiocarbamate” group encompasses O-thiocarbamyl and N-thiocarbamyl groups.

A “C-amido” group refers to a —C(═O)—NR′R″ group, where each of R′ and R″ is as defined herein.

An “N-amido” group refers to an R′C(═O)—NR″— group, where each of R′ and R″ is as defined herein.

An “amide” or “amido” group encompasses C-amido and N-amido groups.

A “urea” group refers to an —N(R′)—C(═O)—NR″R′″ group, where each of R′, R″ and R′″ is as defined herein.

A “thiourea” group refers to a —N(R′)—C(═S)—NR″R′″ group, where each of R′, R″ and R′″ is as defined herein.

A “nitro” group refers to an —NO₂ group.

A “cyano” group refers to a —C≡N group.

The term “phosphonyl” or “phosphonate” describes a —P(═O)(OR′) (OR″) group, with R′ and R″ as defined hereinabove.

The term “phosphate” describes an —O—P(═O)(OR′) (OR″) group, with each of R′ and R″ as defined hereinabove.

The term “phosphinyl” describes a —PR′R″ group, with each of R′ and R″ as defined hereinabove.

The term “hydrazine” describes a —NR′—NR″R′″ group, with R′, R″, and R′″ as defined herein.

As used herein, the term “hydrazide” describes a —C(═O)—NR′—NR″R′″ group, where R′, R″ and R′ are as defined herein.

As used herein, the term “thiohydrazide” describes a —C(═S)—NR′—NR″R′″ group, where R′, R″ and R′″ are as defined herein.

A “guanidinyl” group refers to an —RaNC(═NRd)-NRbRc group, where each of Ra, Rb, Rc and Rd can be as defined herein for R′ and R″.

A “guanyl” or “guanine” group refers to an RaRbNC(═NRd)- group, where Ra, Rb and Rd are as defined herein.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

### Materials and Methods

Materials:

Dibromoacetic acid (DBA) and dichloroacetic acid (DCA) were obtained from Alfa Aesar.

Ethanol was obtained from BioLab Ltd.

Hydrochloric acid (37%) was obtained from Sigma Aldrich.

Methyl-trimethoxysilane (MTMOS) was obtained from Alfa Aesar.

Monobromoacetic acid (MBA) and monochloroacetic acid (MCA) were obtained from Alfa Aesar.

Sodium borohydride (98%) was obtained from Alfa Aesar.

Tetraethoxysilane (TEOS) was obtained from Merck.

Tribromoacetic acid (TBA) and trichloroacetic acid (TCA) were obtained from Alfa Aesar.

Zero valent iron (ZVI)-nanoparticles (Z-Loy™ MicroMetal) were obtained from Onmaterials, stabilized with PEG and characterized by an average particle size of 3 μm.

H₂O was purified using a Millipore (Milli-Q) setup, final resistance >10 MΩ/cm. All chemical stock solutions were prepared using Millipore water.

Powder X-Ray Diffraction (PXRD):

Powder X-ray diffraction (PXRD) measurements were performed with an X'Pert™ PRO™ diffractometer (PANalytical) using Cu Kα□ radiation (□=0.154 nm) and equipped with X'Pert™ High Score Plus™ software. The scanning was done for a 2θ angle from 2° to 100°, with a step time of 2 seconds. Average crystallite size of Fe was calculated based on the characteristic (311) peak, using the Scherer formula:

D=kλ/β cos θ

wherein D=mean crystallite size, k is the geometric factor, λ=x-ray wavelength, β is FWHM (full width at half maximum) of the diffraction peak and θ is the diffraction angle.

Brunauer-Emmett-Teller (BET) Measurements:

After preheating samples under vacuum to 100° C., N₂ adsorption-desorption isotherms were then measured for powder matrices at liquid nitrogen temperature using a NOVA 3200E® surface area analyzer (Quantachrome), and surface parameters were calculated according to the Brunauer-Emmett-Teller (BET) method.

Fourier Transform Infra-Red (FT-IR) Spectroscopy:

FT-IR spectroscopic measurements were performed using a Spectrum One™ FT-IR spectrometer (Perkin Elmer).

Scanning electron microscopy (SEM) with X-ray energy dispersive spectroscopy (EDS):

Scanning electron microscopy (SEM) with X-ray energy dispersive spectroscopy (EDS) was performed with a CARL ZEISS electron microscope.

### Example 1

### Preparation of Matrix with Entrapped Zero Valent Ion Nanoparticles (ZVI-NP)

Tetraethoxysilane (TEOS) (2.77 gram, 0.0133 mol) and methyl-trimethoxysilane (MTMOS) (0.776 gram, 0.0057 mol) were dissolved in ethanol (3.49 gram, 0.076 mol), and a mixture of H₂O (1.365 gram, 0.076 mol) and 37% HCl (0.037 gram, 0.38 mmol) was added dropwise to this solution in accordance with procedures described by [Fagadar-Cosma et al., Open Chem Biomed Methods J 2009, 2:99-106]. The solution was stirred for 15 minutes and then the pH was raised to 9.0 by adding few drops of NH₃ solution. A suspension of zero valent iron nanoparticles (ZVI-NP) (1.15 mL, 15 mmol) was then added and stirred for the next 30 minutes. The suspension was kept for gelation at room temperature for 7 days. The obtained matrix (M69) was ground into powder form by pestle and mortar and utilized for further experiments. Another matrix (M70) was prepared with TEOS (3.95 gram, 0.019 mol) via an analogous procedure.

The ZVI-entrapped matrix M69 was characterized using powder X-ray diffraction (PXRD) measurements, performed as described herein above.

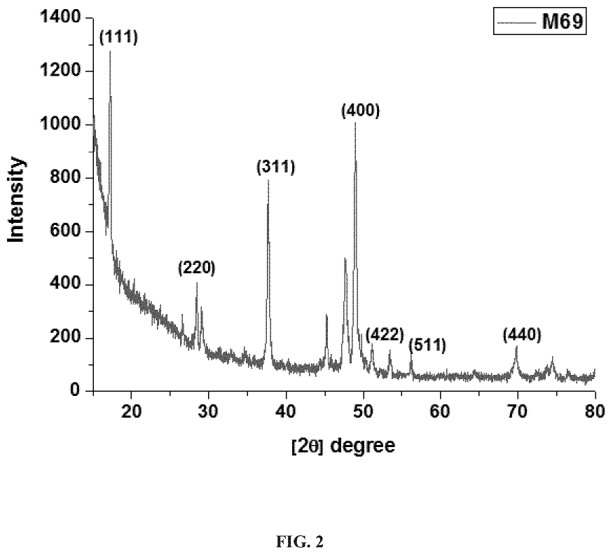

As shown in FIG. 2, diffraction peaks of the M69 matrix were observed for the (220), (311), (400), (422), (511) and (440) iron planes, via powder X-ray diffraction (PXRD).

The average crystallite size (D) for the ZVI-NPs in the matrix was determined to be 13 nm based on the peak for the (311) plane (as described herein above). It is noted that each ZVI particle may comprise many crystallites.

The surface areas of the M69 and M70 ZVI-matrices were characterized by Brunauer-Emmett-Teller (BET) measurements, using N₂-adsorption-desorption isotherms, according to procedures described herein above.

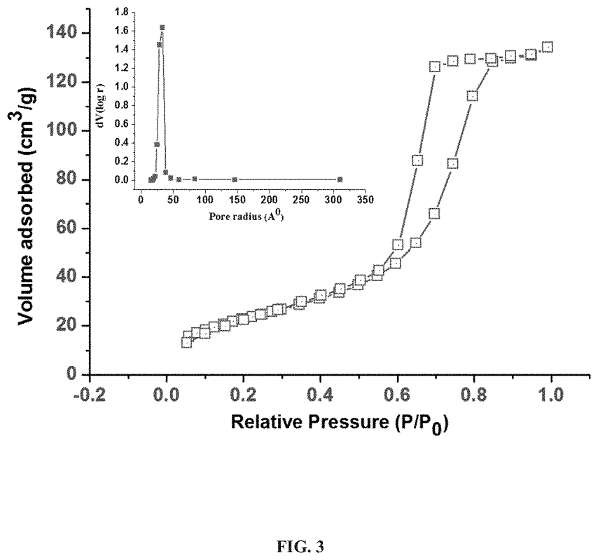

Table 1 below shows the specific surface area (S_{BET}), average pore radius, adsorption pore volume (Vₚ), and pore size distribution (PSD) of the M69 and M70 matrices, as determined by BET measurements. The N₂-adsorption-desorption isotherm and pore radius distribution of M69 matrix are shown in FIG. 3.

TABLE 1
Surface area parameters of sol-gel matrices with 2 × 10⁻⁴ mmol ZVI

| | | Average | Specific | Adsorption | Pore size |
|---|---|---|---|---|---|
| | Silica | pore radius | surface area | pore volume | distribution |
| Sample | composition | (nm) | (m²gram⁻¹) | (cm³ gram⁻¹) | (nm) |
| M69 | 70% TEOS | 4.8 | 86 | 0.20 | 1.5-14.6 |
| | 30% MTMOS | | | | |
| M70 | 100% TEOS | 4.8 | 72 | 0.17 | 1.7-25.5 |

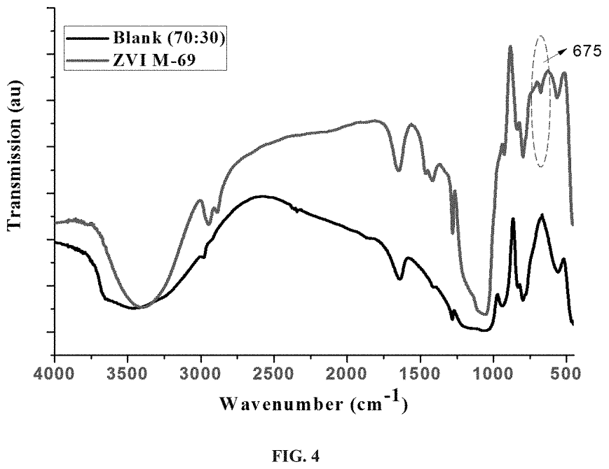

As shown in FIG. 4, the M69 matrix exhibited a strong infrared band at 675 cm⁻¹ (as determined by FT-IR spectroscopy) which is not present in a control gel without iron nanoparticles, indicating the presence of a Si—O—Fe bond in the matrix.

As further shown therein, the M69 matrix further exhibited a band around 1090 cm⁻¹, which is due to the stretching vibrations of the framework Si—O—Si bonds where 0 atoms bridge between two silicon sites.

Assessment of surface morphological characteristics and elemental composition of the ZVI-matrix were performed using scanning electron microscopy (SEM) with X-ray energy dispersive spectroscopy (EDS).

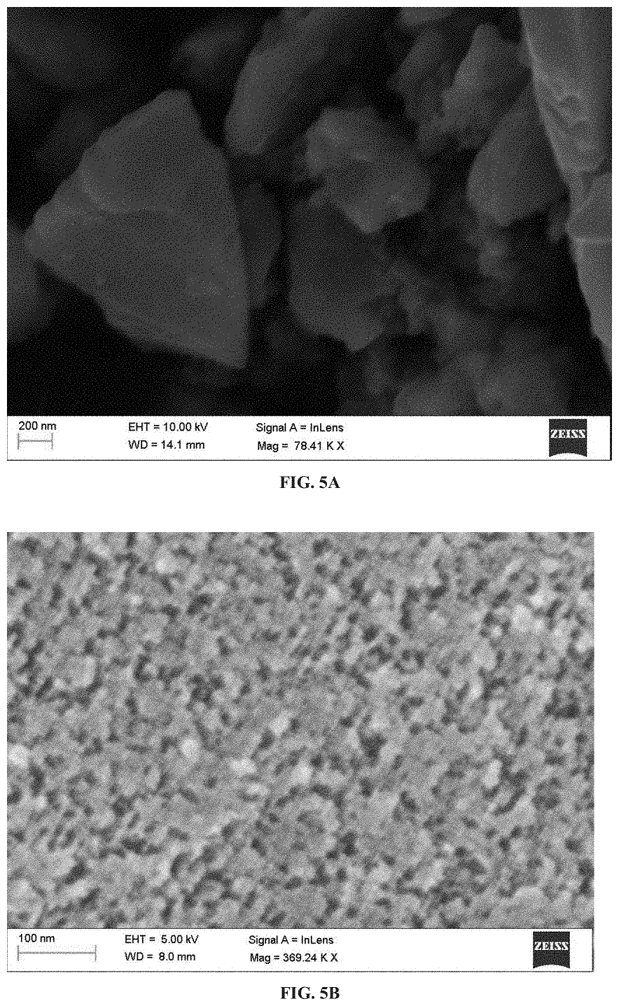

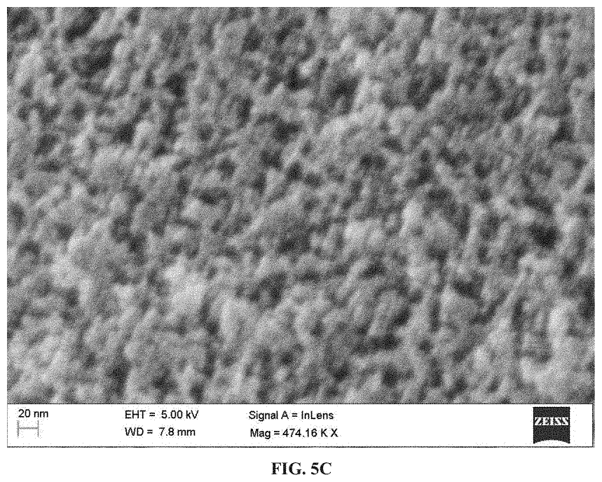

As shown in FIGS. 5A, 5B and 5C, no distinct iron particles were observed on the surface of M69 ZVI-matrix particles by scanning electron microscopy.

However, as shown in FIGS. 5B and 5C, pores were clearly visible on the surface of M69 ZVI-matrix particles.

As shown in FIG. 6, the M69 ZVI-matrix was composed of the elements Fe, Si and O, as determined by X-ray energy dispersive spectroscopy (EDS); with the elemental composition of the matrix being 40.75% Si, 53.06% 0 and 6.19% Fe by weight, and 29.74% Si, 67.99% 0 and 2.27% Fe by percentage of atoms.

These results indicate the successful entrapment of ZVI-nanoparticles inside the silica network.

### Example 2

### ZVI-Matrix Catalytic Activity for De-Halogenation of Halo-Acetic Acids

The degradation of halo-acetic acids was investigated at pH 8.0 in 50 mL glass vials. In a typical procedure, 0.10 gram of the catalyst was put into a glass vial, and 3.0 mL was added of a solution containing 0.010 M of the substrate. A stock solution of NaBH₄ was prepared (0.020 M) and added (9.0 mL) to the vial by slow addition (1.5 mL after every 60 minutes). A substrate: borohydride molar ratio of 1:6 (2×10⁻³/1.2×10⁻² mol-substrate/mol-borohydride) was maintained. De-aerated water (pH 8.0) was added to complete a total volume of 20 mL of reaction solution. The solution was stirred for 60 minutes to ensure completion of the reaction. The reaction suspension was filtered and the degradation of the halo-organic acids was monitored by HPLC.

As ZVI is a reducing agent capable of de-halogenating halo-organic compounds, an effort was made to use the matrix in the absence of BH₄⁻. The results showed that the de-halogenation process was very slow. The use of the ZVI-matrices as redox catalysts for the de-halogenation process was then investigated. The results are summarized in Tables 2 and 3 below:

TABLE 2
Products of halo-acid de-halogenation with ZIV-matrix
as catalyst upon addition of NaBH₄ in one portion

| | Products | | | | | |
|---|---|---|---|---|---|---|
| | (X═Cl or Br) | | | | | |
| | CH₃CO₂H | (CH₂)₂(CO₂H)₂ | C₂H₂O₃ | X₃CCO₂H | X₂CHCO₂H | XCH₂CO₂H |
| Substrate | (%) | (%) | (%) | (%) | (%) | (%) |
| Br₃CCO₂H | 33.5 | 65.0 | — | — | — | 1.5 |
| BrCH₂CO₂H | 96.3 | — | — | — | — | 3.7 |
| Cl₃CCO₂H | 17.5 | — | 43.0 | 19.0 | 21.0 | — |
| ClCH₂CO₂H | 22.0 | — | — | — | — | 78.0 |

TABLE 3
Products of chloro-acid de-halogenation with ZIV-
matrix as catalyst upon slow addition of NaBH₄

| | Products | | | | | |
|---|---|---|---|---|---|---|
| | CH₃CO₂H | (CH₂)₂(CO₂H)₂ | C₂H₂O₃ | Cl₃CCO₂H | Cl₂CHCO₂H | ClCH₂CO₂H |
| Substrate | (%) | (%) | (%) | (%) | (%) | (%) |
| Cl₃CCO₂H | 21.0 | — | 48.7 | — | 30.3 | — |
| ClCH₂CO₂H | 22.5 | — | — | — | — | 77.5 |

As shown in Table 2, the yields for de-bromination were considerably larger than those for de-chlorination.

These results may be attributed to C—Cl bonds being stronger than C—Br bonds, and suggest that the active reducing agents are (Fe⁰—NP)—Hₙ₊ₘ^{(n-m)-} formed via:

Fe⁰NP+(n/4)BH₄⁻+(3n/4)H₂O→(Fe⁰—NP)—Hₙⁿ⁻+(n/4)B(OH)₃+(3n/4)H+ (1)

followed by:

(Fe⁰—NP)—Hₙⁿ⁻+mH₂O⇄(Fe⁰—NP)—ₙ₊ₘ^{(n-m)-}+mOH⁻ (2)

In the absence of an oxidizing substrate these reactions are followed by reactions (3) and/or (4), whereas in the presence of an oxidizing substrate, reactions (3) & (4) compete with the reduction of the substrate:

(Fe⁰—NP)—Hₙ₊ₘ^{(n-m)-}→(Fe⁰—NP)—Hₙ₊ₘ₋₂^{(n-m)-}+H₂ (3)

(Fe⁰—NP)—Hₙ₊ₘ^{(n-m)-}+H₂O→(Fe⁰—NP)—Hₙ₊ₘ₋₂^{(n-m-1)-}+H₂+OH⁻ (4)

The active reducing agent (Fe⁰—NP)—Hₙ₊ₘ^{(n-m)-} in the reductions of the chloro-organic compounds has to be a stronger reducing agent and therefore the competition of reactions (3) & (4) with the de-chlorination will be stronger than in the de-bromination processes.

As shown in Table 2, de-bromination was a more efficient process than the corresponding de-chlorination, as expected in view of the C—Br bonds being weaker than C—Cl bonds (as discussed herein above).

As further shown in Table 2, succinic acid (a product of dimerization of carboxymethyl radicals) was the major product of the de-bromination of Br₃CCO₂⁻.

This result indicates that radicals are intermediates in the de-bromination process. In this respect, the results are similar to those previously reported for the catalytic de-bromination on Au°—NPs reported by Adhikary et al. [Eur J Inorg Chem 2017, 1510-1515]. In view of reports by Rusonik et al. [Eur J Inorg Chem 2003, 4227-4233; Eur J Inorg Chem 2005, 1227-1229; Glass Phys Chem 2005, 31:115-118; Inorg Chem 2006, 45:7389-7396; Eur J Inorg Chem 2010, 3252-3255] indicating that alkyl radicals react in fast reaction with Fe°, it is reasonable to conclude that two radicals chemically adsorbed to the Fe⁰—NPs dimerize on the surfaces of the Fe⁰—NPs.

As further shown in Table 2, the concentration of CH₂BrCO₂⁻ at the end of the de-bromination process was higher in the reduction of CH₂BrCO₂⁻ than in the reduction of Br₃CCO₂⁻ (although clearly the excess reducing power is larger in the former case).

This result indicates that in the competition between the following reactions, reaction (7) is considerably faster than reactions (5) & (6):

Hₗ—(Fe⁰—NP)—(CHBrCO₂⁻)ₖ^{y-}+H₂O→Hₗ—(Fe⁰—NP)—(CHBrCO₂⁻)ₖ₋₁^{(y-2)-}+CH₂BrCO₂⁻+OH⁻ (5)

Hₗ—(Fe⁰—NP)—(CHBrCO₂⁻)ₖ^{y-}→Hₗ₋₁—(Fe⁰—NP)—(CHBrCO₂⁻)ₖ₋₁^{(y-1)-}+CH₂BrCO₂⁻ (6)

Hₗ—(Fe⁰—NP)—(CHBrCO₂⁻)ₖ^{y-}→Hₗ—(Fe⁰—NP)—(CHBrCO₂⁻)ₖ₋₁-(C^{-δ}HCO₂⁻)^{(y-1)-}+Br⁻ (7)

followed by:

Hₗ—(Fe⁰—NP)—(CHBrCO₂⁻)ₖ₋₁-(C^{-δ}HCO₂⁻)^{(y-1)-}+2H₂O→Hₗ—(Fe⁰—NP)—(CHBrCO₂⁻)ₖ₋₁^{(y-3)-}+CH₃CO₂⁻+2OH⁻ (8)

If reaction (5) or (6) were faster than reaction (7), then CH₂BrCO₂⁻ would have been a more important end product of the de-bromination of Br₃CCO₂⁻, in comparison to the CH₂BrCO₂⁻ remaining upon de-bromination of CH₂BrCO₂⁻.

As further shown in Tables 2 and 3, reduction of Cl₃CCO₂⁻ and reduction of Br₃CCO₂⁻ resulted in completely different products, with CH(O)CO₂⁻ being a major product of de-chlorination.

These results indicate that the mechanisms of the de-bromination and de-chlorination reactions are considerably different. In particular, the formation of CH(O)CO₂⁻ as a major product of the de-chlorination suggests that the mechanism is analogous to that observed for Fe⁰—NPs on which a large negative potential is applied, as described by Rusonik et al. [Eur J Inorg Chem 2010, 3252-3255].

Hₗ—(Fe⁰—NP)—(CCl₂CO₂⁻)ₖ^{y-}→Hₗ—(Fe⁰—NP)—(CCl₂CO₂⁻)ₖ₋₁-(C^{+δ}ClCO₂⁻)^{(y-1)-}+Cl⁻ (9)

Hₗ—(Fe⁰—NP)—(CCl₂CO₂⁻)ₖ₋₁-(C^{+δ}ClCO₂⁻)^{(y-1)-}+H₂O→Hₗ—(Fe⁰—NP)—(CCl₂CO₂⁻)ₖ₋₁-(C(OH)ClCO₂⁻)^{y-}+H⁺ (10)

Hₗ—(Fe⁰—NP)—(CCl₂CO₂⁻)ₖ₋₁-(C(OH)ClCO₂⁻)^{y-}→Hₗ—(Fe⁰—NP)—(CCl₂CO₂⁻)ₖ₋₁-(C(O)CCO₂⁻)^{y-}+H⁺+Cl⁻ (11)

Hₗ—(Fe⁰—NP)—(CCl₂CO₂⁻)ₖ₋₁-(C(O)CCO₂⁻)^{y-}+H₂O→Hₗ—(Fe⁰—NP)—(CCl₂CO₂⁻)ₖ₋₁^{(y-2)-}+CH(O)CCO₂⁻+OH⁻ (12)

The major difference is between the partial charge on the carbon in Hₗ—(Fe⁰—NP)—(CCl₂CO₂⁻)ₖ₋₁-(C^{+δ}ClCO₂⁻)^{(y-1)-} (during de-chlorination) and in Hₗ—(Fe⁰—NP)—(CH₂BrCO₂⁻)ₖ₋₁-(C^{-δ}H₂CO₂⁻)^{(y- 1)-} (during de-bromination).

Without being bound by any particular theory, it is believed that the source of this difference in the partial charge (+δ during de-chlorination, −δ during de-bromination) is the larger negative charge on the Fe—NP in Hₗ—(Fe⁰—NP)—(CCl₂CO₂⁻)ₖ₋₁-(C^{+δ}ClCO₂⁻)^{(y-1)-}, which is due to de-chlorination requiring a stronger reducing agent, and which is similar to the required negative bias on the electrode as reported in the study by Rusonik et al. [Eur J Inorg Chem 2010, 3252-3255].

As further shown in Table 3, de-halogenation with slow addition of BH₄⁻ resulted in different products than did de-halogenation with rapid addition of BH₄⁻ (as shown in Table 2).

This result suggests that the concentration of BH₄⁻ affects the redox potential of the (Fe⁰—NP)—Hₙ₊ₘ^{(n-m)-} formed as transients in the various mechanisms.

The same matrix was utilized five times for each reaction and the results were independent of the number of times the matrix was used (data not shown). These results indicate that the matrix is highly reversible in nature.

Furthermore, the products of reduction of Cl₃CCO₂⁻ on Fe⁰—NPs (as shown in Tables 2 and 3) differ from those of reduction on Au°—NPs, as reported by Adhikary et al. [Eur J Inorg Chem 2017, 1510-1515].

These results indicate that the de-halogenation mechanism depends on the zero valent metal used.

Without being bound by any particular theory, it is believed that the different mechanism on ZVI is due to the different over-potentials for H₂ release from NPs of different metals and/or to the different M°-CR¹R²R³ and M°-H bond strengths for the different metals.

Taken together, the above results indicate that the ZVI-NPs entrapped in the silica sol-gel matrices efficiently catalyze de-halogenation of halo-organic acids, that the products of de-chlorination and de-bromination may differ considerably, that the de-halogenation products obtained with ZVI differ from those obtained with Au, and that the de-halogenation mechanism is affected by the rate of addition of the reducing agent. The results also demonstrate that the same matrix can be repeatedly used as a catalyst without affecting its efficiency.

### Example 3

### ZVI-Matrix Catalytic Activity for Reduction of 4-Nitrophenol and Bromate

In order to assess whether ZVI-entrapped matrices are effective at catalyzing reduction processes other than de-halogenation, the reduction of 4-nitrophenol and of bromate were investigated. 4-nitrophenol and bromate are pollutants which typically prefer reductions by two electron processes [Ghosh et al., Appl Catal A Gen 2004, 268:61-66; Li et al., Sensors Actuators B Chem 2005, 107:921-928] and therefore the expected processes are:

(Fe⁰—NP)—Hₙ₊ₘ^{(n-m)-}+BrO₃⁻→(Fe⁰—NP)—Hₙ₊ₘ₋₁^{(n-m-1)-}+BrO₂⁻+OH⁻ (13)

(Fe⁰—NP)—Hₙ₊ₘ^{(n-m)-}+4—O₂N—C₆H₄OH→(Fe⁰—NP)—Hₙ₊ₘ₋₁^{(n-m-1)-}+4—ON—C₆H₄OH+OH⁻ (14)

These reactions are followed by the reductions of BrO₂⁻ and 4-ON—C₆H₄OH, which are easier to reduce than the original pollutants, to finally yield BP and 4-H₂N—C₆H₄OH.

The reductions of 4-nitrophenol and bromate were carried out at pH 8.0 in 50 mL glass vials. In a typical procedure, 0.20 gram of the catalyst was placed in a glass vial and 4.0 mL of a solution containing 0.010 M of the substrate was added to this. 12.0 mL of a stock solution of NaBH₄ (0.20 M) was added to the vial by slow addition (2 mL after every 60 minutes). A substrate: borohydride molar ratio of 1:6 (4×10⁻⁴/2.4×10⁻³ (mol substrate)/(mol borohydride) was maintained. 4 mL of de-aerated water, pH 8.0, was added to complete a total volume of 20 mL of reaction solution. The solution was stirred for 60 minutes to ensure completion of the reaction. The suspension was filtered and amounts of the reaction products 4-aminophenol and BP were determined. The formation of 4-aminophenol was monitored by the UV-visible absorption of the pollutant and of the amine formed, and the reduction of bromate was monitored by ion chromatography.

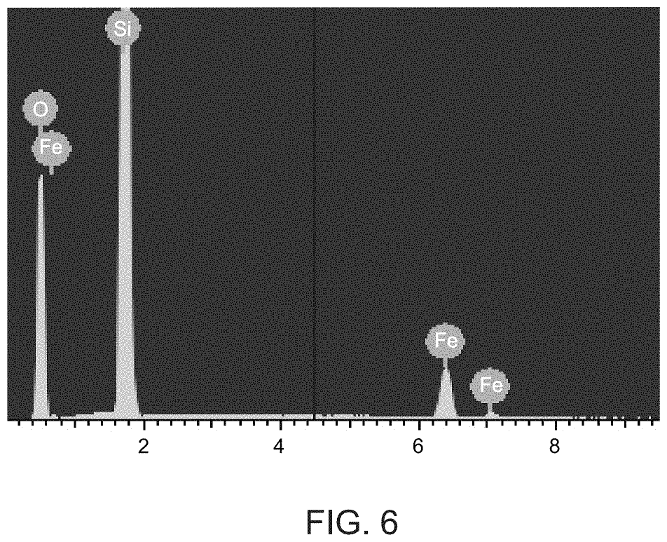

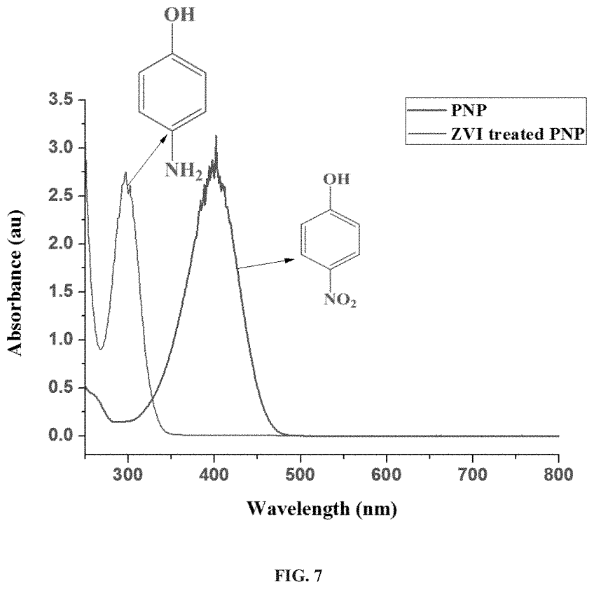

As shown in FIG. 7, 4-nitrophenol was completely reduced to 4-aminophenol, as determined by UV-visible spectroscopy.

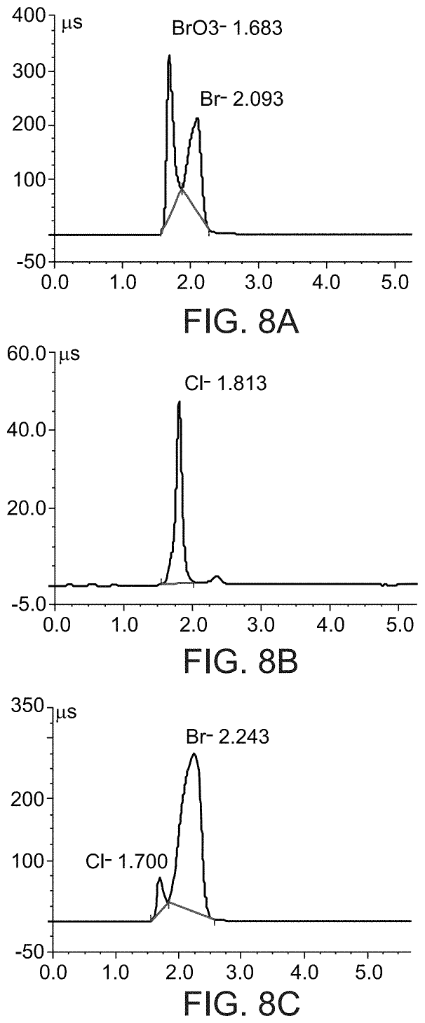

As shown in FIGS. 8A-8C, bromate ion was completely reduced to bromide ion, as determined by ion chromatography.

These results indicate that ZVI-NPs are effective catalysts for reducing a variety of compounds with different chemical properties.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

In addition, any priority document(s) of this application is/are hereby incorporated herein by reference in its/their entirety.

1. A method of reducing a substrate, the method comprising contacting the substrate with a catalytic amount of zero valent iron particles and with a reducing agent, wherein said zero valent iron particles mediate transfer of an electron, hydrogen atom and/or hydride ion from said reducing agent to said substrate, thereby reducing the substrate.

2. The method of claim 1, wherein a molar ratio of an amount of said substrate which is reduced to said catalytic amount is at least 10:1 (substrate: iron).

3. The method of claim 1, being effected by transfer of electrons, hydrogen atoms and/or hydride ions from said reducing agent to said zero valent iron particles so as to form zero valent iron particles with a negative charge and at least one hydrogen atom bound thereto.

4. The method of claim 1, wherein said reducing agent is characterized by a standard redox potential which is −0.5 V_{SHE} or more negative, in aqueous solution at pH 8.

5. The method of claim 4, wherein said standard redox potential is −0.7 V_{SHE} or more negative, in aqueous solution at pH 8.

6. The method of claim 1, wherein said zero valent iron particles comprise zero valent iron nanoparticles.

7. The method of claim 1, wherein said zero valent iron particles are embedded in a porous matrix.

8. (canceled)

9. The method of claim 1, wherein said reducing agent is selected from the group consisting of a borohydride, a metal aluminum hydride, a borane, an aluminum hydride, an alkali metal or alloy thereof, an alkaline earth metal or alloy thereof, zinc or alloy thereof, tin or alloy thereof, a tin hydride, a tin(II) halide, aluminum or alloy thereof, a silane, an azide salt, hydroxylamine, hydrazine, diimide and formic acid.

10. The method of claim 1, wherein said contacting said substrate with said zero valent iron particles is effected in aqueous solution.

11. The method of claim 10, wherein said reducing agent is characterized by a standard redox potential which is −0.5 V_{RHE} or less negative.

12. The method of claim 1, wherein said contacting said substrate with said zero valent iron particles is effected in a protic organic solvent and/or in an aprotic organic solvent.

13. The method of claim 1, wherein said substrate is a precursor or an intermediate in the synthesis of a product, and the method comprises reducing said substrate to said product or to an additional intermediate in the synthesis of said product.

14. The method of claim 1, wherein said substrate is hazardous and/or environmentally harmful.

15. (canceled)

16. The method of claim 1, wherein said substrate is selected from the group consisting of a halo-organic compound, bromate, nitrate and a nitro-organic compound.

17. The method of claim 16, wherein said substrate comprises a halo-organic compound and the method comprises reducing said substrate to a non-halogenated organic compound.

18-19. (canceled)

20. The method of claim 16, wherein said substrate comprises bromate, and the method comprises reducing said bromate to bromide.

21. The method of claim 16, wherein said substrate comprises a nitro-organic compound and the method comprises reducing said substrate to an amino-organic compound.

22. (canceled)

23. The method of claim 16, wherein said substrate comprises nitrate, and the method comprises reducing said nitrate to ammonia, nitrogen gas and/or hydrazine.

24. A system for reducing a substrate, the system comprising zero valent iron particles embedded in a porous matrix, wherein the system is configured for contacting the substrate and a reducing agent with a catalytic amount of said zero valent iron particles in said porous matrix.

25. The system of claim 24, being configured for effecting flow of a fluid comprising said substrate and/or of a fluid comprising said reducing agent through said porous matrix.

26. The system of claim 24, wherein a molar ratio of an amount of said substrate to said catalytic amount is at least 10:1 (substrate: iron).

27. The system of claim 24, wherein said zero valent iron particles comprise zero valent iron nanoparticles.

28. The system of claim 24, wherein said porous matrix comprises a substance selected from the group consisting of a silica gel, a zeolite, titania and alumina.

29. The system of claim 24, wherein said reducing agent is characterized by a standard redox potential which is −0.5 V_{SHE} or more negative, in aqueous solution at pH 8.

30. (canceled)

31. The system of claim 24, wherein said reducing agent is selected from the group consisting of a borohydride, a metal aluminum hydride, a borane, an aluminum hydride, an alkali metal or alloy thereof, an alkaline earth metal or alloy thereof, zinc or alloy thereof, tin or alloy thereof, a tin hydride, a tin(II) halide, aluminum or alloy thereof, a silane, an azide salt, hydroxylamine, hydrazine, diimide and formic acid.

32. The system of claim 24, wherein said substrate is a precursor or an intermediate in the synthesis of a product, and the system is configured for reducing said substrate to said product or to an additional intermediate in the synthesis of said product.

33. The system of claim 24, wherein said substrate is hazardous and/or environmentally harmful.

34. (canceled)

35. The system of claim 24, being configured for effecting flow of water comprising said substrate through said porous matrix, the system being for decontamination of water.

36. (canceled)

37. The system of claim 24, wherein said fluid comprising said substrate comprises a protic or aprotic organic solvent comprising said substrate.

38. The system of claim 24, wherein said substrate is selected from the group consisting of a halo-organic compound, bromate, nitrate and a nitro-organic compound.
